(19) United States
(12) Patent Application Publication
(10) Pub. No.: US 2016/0355205 A1
(43) Pub. Date: Dec. 8, 2016

(54) Device Holding Clip for Shopping Cart

(71) Applicants: Cheryl Glynn Upton, Hennessey, OK (US); Bobby Dale Upton, Hennessey, OK (US)

(72) Inventors: Cheryl Glynn Upton, Hennessey, OK (US); Bobby Dale Upton, Hennessey, OK (US)

(21) Appl. No.: 15/169,958

(22) Filed: Jun. 1, 2016

Related U.S. Application Data
(60) Provisional application No. 62/194,637, filed on Jul. 20, 2015.

(51) Int. Cl. B62B 5/00; F16B 2/10; F16M 11/06; F16M 13/02

(52) U.S. Cl. CPC B62B 5/00; F16M 13/022; F16B 2/10; F16M 11/06

(57) ABSTRACT

Smart phones and tablet computers not only provide phone service, email and internet access, but also serve as a device for organizing information, compiling shopping lists, comparing shopping prices, viewing nutritional information, and the like. As such, such devices are referred to by many while grocery shopping or other store locations where shopping carts are used. Many find it difficult to hold the mobile device while also trying to push the cart. Some people may even drop their mobile device thus causing costly damage. If one should constantly put the device back in their pocket or purse, only to pull it out again in a few feet, one would waste valuable time in the process. Accordingly, there exists a need for a means by which a mobile communication device can be easily accessed while using a shopping cart. The development of the device holding clip fulfills this need.

### DESCRIPTION OF THE DRAWING

The advantages and features of the present invention will become better understood with reference to the following more detailed description and claims taken in conjunction with the accompanying drawing, in which like elements are identified with like symbols, and in which:

FIG. 1 is a perspective view of a device holding clip 10 according to an embodiment of the present invention.

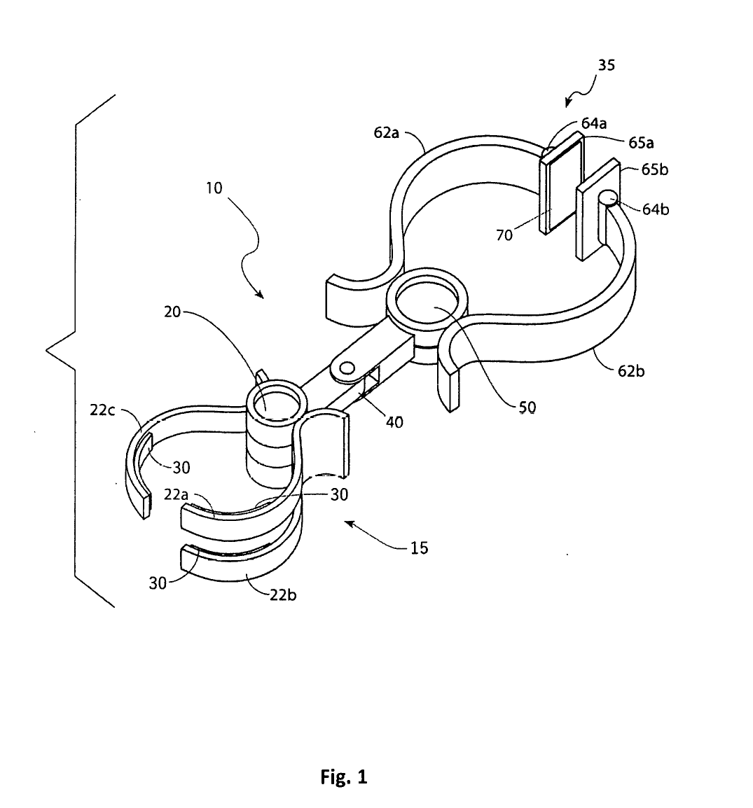

### DESCRIPTIVE KEY

10 device holding clip
15 first end
20 connection point
22a first finger clamp
22b second finger clamp
22c third finger clamp
30 first end grip
35 second end
40 pivot knuckle
50 swivel joint
62a second end first arm
62b second end second arm
64a first arm swivel
64b second arm swivel
65a first arm clamp plate
65b second arm clamp plate
70 second end grip

### DESCRIPTION OF INVENTION

The device holding clip 10 is capable of temporarily holding and supporting a mobile communication device to a shopping cart while shopping. The clip 10 includes a spring-loaded swivel joint 50 which utilizes a clamshell-style clamp 62a, 62b and a three-finger-style clamp having finger clamps 22a, 22b, 22c. These features function to support a device to the clip 10 and also to attach the clip 10 to a support structure, preferably to a handle area of the shopping cart, simultaneously. A first end 15 of the clip 10 has included the three-finger clamp, having a connection point 20, a first and second clamp finger 22a, 22b commonly attached to the connection point 20 and opposing third finger clamp 22c attached to the connection point 20.

A second end 35 of the clip 10 has a first clamp arm 62a with a first arm clamp plate 65a and a second clamp arm 62b with a second arm clamp plate 65b capable of removably securing an electronic device, such as a smartphone or tablet, thereto. The clamp plates 65a, 65b are attached to distal ends of a respective clamp arm 62a, 62b via respective swivels 64a, 64b to assist in securing multiple sizes and configurations of items to the second end 35.

The middle portion of the clip 10 is provided with an adjustable pivot knuckle joint 40 which permits rotation of the second end 35 relative to the first end 15 along a vertical axis and is capable of locking in place at one (1) of a multiple of pre-determined positions. The finger clamps 22a, 22b, 22c of the first end 15, as well as the open clamp arms 62a, 62b of the second end 35, each faces away from the center of the clip 10. The clamp arms 62a, 62b of the second end 35 are connected via a swivel joint 50 to allow for disposition of the second end 35 at one (1) of a multitude of positions radial relative to the first end 15.

The finger clamps 22a, 22b, 22c are each lined with a first end grip 30, preferably a slip-resistant rubber coating on a inner surface thereof, to securely adapt to the shopping cart frame. The clamp plates 65a, 65b are each similarly lined with a second end grip 70, preferably a slip-resistant rubber coating on an inner surface thereto, to enable an item to be securely adapted thereto. As such, the clip 10 is perfectly positioned in a hands-free manner to hold the item while it is easily viewed and accessed while pushing the cart. The clip 10 may also be rotated and used to entertain an occupant seated within the seat of the shopping cart without worry of the child dropping the item. The use of the clip 10 allows users of shopping carts the ability to safely and easily utilize mobile communication devices while shopping to help make the shopping experience easier and simpler.

The materials required to produce the clip 10 are all readily available and well known to manufacturers of goods of this type. The majority of the invention would be made of impact resistant plastic in an injection molding process. Such a process would require the design and use of custom molds. The remaining components of the present invention such as fasteners, springs, rubber coating, and the like, would best be procured form manufacturers and wholesalers that deal in goods of that nature and assembled at a final location. The relatively simple design and the material of construction make the clip 10 a cost-effective design due to the relatively low material and labor costs involved. Final production of the clip 10 will be performed by manufacturing workers of average skill.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various modifications as are suited to the particular use contemplated.

What is claimed is:

1. A device clip, comprising:
a first stem, having a first end and a second end;
a second stem having a first end pivotally attached to said first stem first end and a second end;
a connection point attached to said first stem second end;
a first and a second finger clamp, each extending from a common attachment arm attached to said connection point;
a third finger clamp attached to said connection point opposite said first and second finger clamp;
a swivel join attached to said second stem second end;
a pair of clamp arms, each having a first end pivotally attached to said swivel joint;
a pair of clamp plates, each attached to one of said pair of clamp arms via an arm swivel joint;
wherein said swivel joint biases said pair of clamp plate towards each other.

2. The clip of claim 1, further comprising a grip located on an inner surface of each of said first, second, and third finger clamps.

3. The clip of claim 1, further comprising a grip located on an inner surface of each of said pair of clamp plates.

4. The clip of claim 1, further comprising a means to secure said first stem at a desired position relative to said second stem.
